(19) United States
(12) Patent Application Publication
(10) Pub. No.: US 2013/0165059 A1
(43) Pub. Date: Jun. 27, 2013

(54) BEAMFORMING APPARATUS AND METHOD IN MOBILE COMMUNICATION SYSTEM

(71) Applicants: Samsung Electronics Co. Ltd., Suwon-si (KR); KOREA ADVANCED INSTITUTE OF SCIENCE AND TECHNOLOGY (KAIST), Daejeon (KR)

(72) Inventors: Mi-Hyun SON, Seoul (KR); Yong-Hoon KIM, Suwon-si (KR); Byung-Tae YOON, Suwon-si (KR); Jong-Wook ZEONG, Seoul (KR); Dong-Geun LEE, Hwaseong-si (KR); Jeong-Seon LEE, Daejeon (KR); Sang-Gug LEE, Daejeon (KR)

(73) Assignees: KOREA ADVANCED INSTITUTE OF SCIENCE AND TECHNOLOGY (KAIST), Daejeon (KR); SAMSUNG ELECTRONICS CO. LTD., Suwon-si (KR)

(21) Appl. No.: 13/727,377

(22) Filed: Dec. 26, 2012

(30) Foreign Application Priority Data
Dec. 23, 2011 (KR) 10-2011-0140823

(51) Int. Cl. H04B 7/04

(52) U.S. Cl. CPC H04B 7/043
USPC 455/101; 455/318; 455/234.1

(57) ABSTRACT

Provided is a beamforming apparatus in a receiver in a mobile communication system. The beamforming apparatus includes a Local Oscillator (LO) signal generator for generating an LO signal; a phase shifter for generating a predetermined number of phase-shifted LO signals with respect to the generated LO signal; a switching network for mapping the phase-shifted LO signals to RF signals received via a plurality of receive paths; and a mixer for mixing the RF signals with the mapped LO signals to down-convert a frequency of the RF signals.

### PRIORITY

This application claims the benefit under 35 U.S.C. §119(a) of a Korean Patent Application filed in the Korean Intellectual Property Office on Dec. 23, 2011 and assigned Serial No. 10-2011-0140823, the entire disclosure of which is incorporated herein by reference.

### JOINT RESEARCH AGREEMENT

The presently claimed invention was made by or on behalf of the below listed parties to a joint research agreement. The joint research agreement was in effect on or before the date the claimed invention was made and the claimed invention was made as a result of activities undertaken within the scope of the joint research agreement. The parties to the joint research agreement are 1) Samsung Electronics Co., Ltd. and 2) Korea Advanced Institute of Science and Technology (KAIST).

### BACKGROUND OF THE INVENTION

1. Field of the Invention

The present invention relates to a beamforming apparatus and method in a mobile communication system.

2. Description of the Related Art

In order to meet the demands for low-carbon and eco-friendly base station facilities, base stations are implemented in the form of integration of antennas and Radio Frequency (RF) front-ends. In addition, for the efficient implementation of high-speed data transmission, the base stations adopt Beamforming and Multiple Input Multiple Output (MIMO) schemes. In this case, multiple modules all need to be included in the existing antenna box, so the implementation of small low-power RF front-end devices has become new technical issues.

When beamforming is performed in an RF band, an Intermediate Frequency (IF) band and a baseband, each path uses its own phase shifter. Accordingly, each antenna needs its own components from an antenna to a Digital Down Converter (DDC), causing an increase in the total number of necessary components.

### SUMMARY OF THE INVENTION

An aspect of exemplary embodiments of the present invention is to provide a method and apparatus for optimizing both the system performance and the number of components.

Another aspect of exemplary embodiments of the present invention is to provide a method and apparatus for minimizing power consumption.

Another aspect of exemplary embodiments of the present invention is to provide a method and apparatus for improving the Signal-to-Noise Ratio (SNR) and reducing the burden on a dynamic range of an Analog-to-Digital Converter (ADC).

In accordance with one aspect of the present invention, there is provided a beamforming apparatus in a receiver in a mobile communication system. The beamforming apparatus includes a Local Oscillator (LO) signal generator for generating an LO signal; a phase shifter for generating a predetermined number of phase-shifted LO signals with respect to the generated LO signal; a switching network for mapping the phase-shifted LO signals to RF signals received via a plurality of receive paths; and a mixer for mixing the RF signals with the mapped LO signals to down-convert a frequency of the RF signals.

In accordance with another aspect of the present invention, there is provided a beamforming method in a receiver in a mobile communication system. The beamforming method includes generating a Local Oscillator (LO) signal; generating a predetermined number of phase-shifted LO signals with respect to the generated LO signal; mapping the phase-shifted LO signals to RF signals received via a plurality of receive paths; and mixing the RF signals with the mapped LO signals to down-convert a frequency of the RF signals.

In accordance with further another aspect of the present invention, there is provided a beamforming apparatus in a transmitter in a mobile communication system. The beamforming apparatus includes a Local Oscillator (LO) signal generator for generating an LO signal; a phase shifter for generating a predetermined number of phase-shifted LO signals with respect to the generated LO signal; a switching network for mapping the phase-shifted LO signals to RF signals to be transmitted via a plurality of transmit paths; and a mixer for mixing signals that have undergone frequency filtering and amplitude adjustment with respect to an Intermediate Frequency (IF) band signal, with the mapped LO signals, to up-convert a frequency of the IF band signals.

In accordance with yet another aspect of the present invention, there is provided a beamforming method in a transmitter in a mobile communication system. The beamforming method includes generating a Local Oscillator (LO) signal; generating a predetermined number of phase-shifted LO signals with respect to the generated LO signal; mapping the phase-shifted LO signals to RF signals to be transmitted via a plurality of transmit paths; and mixing signals that have undergone frequency filtering and amplitude adjustment with respect to an Intermediate Frequency (IF) band signal, with the mapped LO signals, to up-convert a frequency of the IF band signals.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating an example of a transmitter performing beamforming in an RF band;

FIG. 2 is a block diagram illustrating an example of a receiver performing beamforming in an IF band;

FIG. 3 is a block diagram illustrating an example of a receiver performing digital beamforming;

FIG. 4 is a block diagram illustrating an example of a receiver in which a beamformer is to be used, according to a first embodiment of the present invention;

FIG. 5 is a block diagram illustrating an example of a transmitter in which a beamformer is to be used, according to the first embodiment of the present invention;

FIG. 6 is a block diagram illustrating a beamformer in a receiver according to a second embodiment of the present invention;

FIG. 7 is a block diagram illustrating a structure of an M-MIMO receiver using beamformer according to a third embodiment of the present invention;

FIG. 8 is a flowchart illustrating a reception operation according to an embodiment of the present invention;

FIG. 9 is a flowchart illustrating a transmission operation according to an embodiment of the present invention; and

FIG. 10 is a flowchart illustrating an LO signal generation method according to an embodiment of the present invention.

Throughout the drawings, the same drawing reference numerals will be understood to refer to the same elements, features and structures.

### DETAILED DESCRIPTION OF EXEMPLARY EMBODIMENTS

Preferred embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The terms used therein are not intended to limit the scope of the present invention, and it will be apparent to those of ordinary skill in the art that the present invention may be applied to any systems having the similar technical background. The scope of the present invention may be extended not only to the wireless communication system components and the technology similar to the wireless communication system components, but also to other electronic devices.

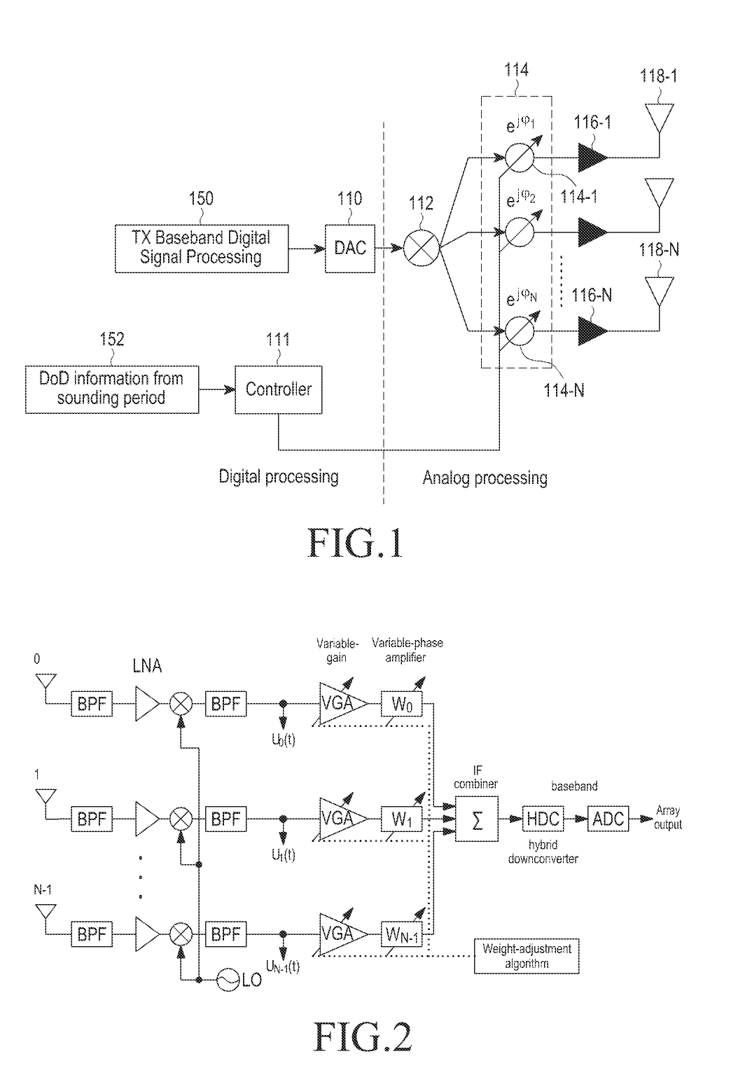

FIG. 1 is a block diagram illustrating an example of a transmitter performing beamforming in an RF band.

A digital baseband transmission signal 150 is converted into an RF signal in a mixer 112 after passing through a Digital-to-Analog Converter (DAC) 110, and then separated into a plurality of signals. The separated signals are converted by a beamforming circuit 114 (commonly consisting of passive phase shifters 114-1, . . . , 114-N and their associated attenuators (not shown)), amplified by power amplifiers 116-1, . . . , 116-N, and transmitted via antennas 118-1, . . . , 118-N, respectively.

FIG. 2 is a block diagram illustrating an example of a receiver performing beamforming in an IF band.

Signals received at a plurality of antennas undergo frequency filtering and amplification in Band Pass Filter (BFPs) and Low Noise Amplifiers (LNAs), and then undergo down conversion-to-IF band and filtering in mixers and BFPs, respectively. These signals are amplified and phase-shifted by a beamformer consisting of Variable Gain Amplifiers (VGAs) and Variable Phase Amplifiers (VPAs), and then converted into a digital signal by being summed up.

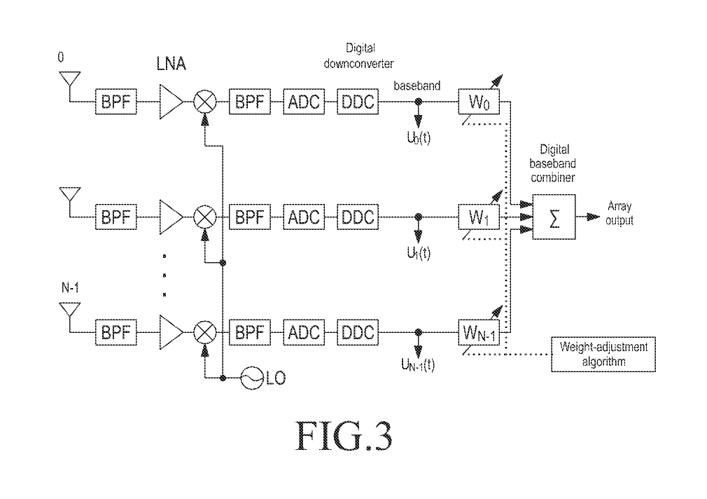

FIG. 3 is a block diagram illustrating an example of a receiver performing digital beamforming.

Signals received at a plurality of antennas undergo frequency filtering and amplification in BPFs and LNAs, and then undergo down conversion-to-IF band and filtering in mixers and BPFs, respectively. Thereafter, the filtered signals are converted into digital signals and converted into baseband signals by Analog-to-Digital Converts (ADCs) and Digital Down Converters (DDCs), phase/amplitude-adjusted by a beamformer consisting of VPAs, and then restored to the original signal by being summed up.

In the case where beamforming is performed in RF, IF and baseband as in the method described with reference to FIGS. 1, 2 and 3, as beamforming is performed after the signals are restored closer to their original signals, the system performance may be improved and the performance requirements (for example, dynamic ranges of ADCs) for circuit blocks may be mitigated. In particular, if beamforming is performed in the digital domain, the accuracy of implementation of the beamformer may be improved. However, for each antenna, components from the antenna to its associated DDC are needed, causing an increase in the total number of required components.

The present invention provides a beamformer and/or a MIMO-based RF front-end device capable of optimizing both the system performance and the number of components.

A beamformer according to an embodiment of the present invention includes mixers, a Local Oscillator (LO) generator, a phase shifter, a switching network, and VGAs.

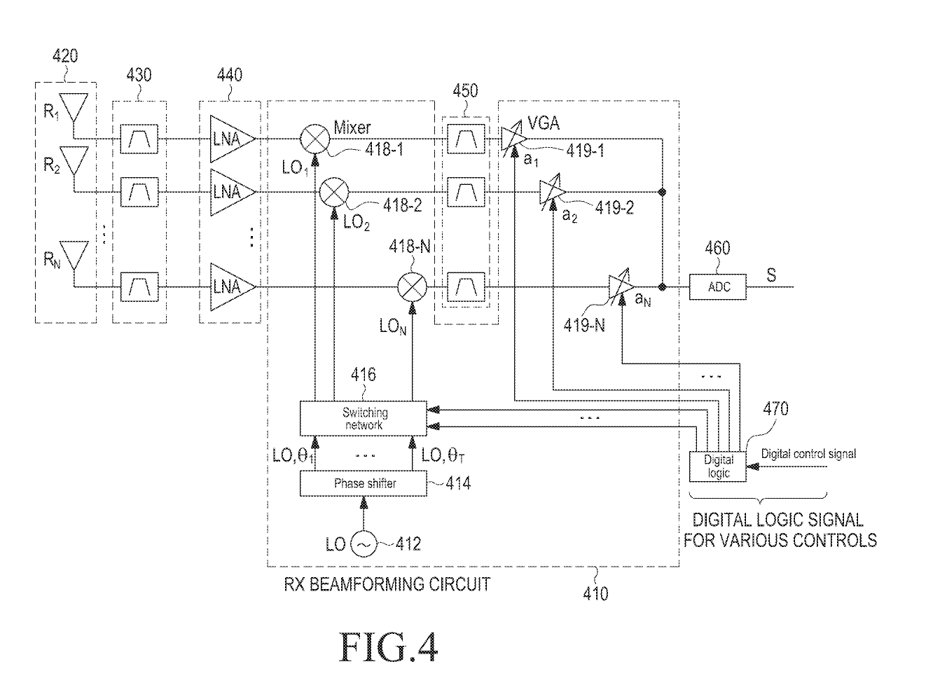

The LO signal generator generates a phase-locked signal. The phase shifter receives a signal generated by the LO signal generator, and outputs T signals whose phases are shifted by θ₁, θ₂, . . . , θ_{T}, respectively. The switching network serves to match one of the T signals output from the phase shifter to N receive paths. For beamforming, phase values needed for each receive path are determined depending on the state of its received signal. An entity for determining these values is another element (for example, a digital processor). If below-described digital logics 470, 570, 670 and 770 in FIGS. 4 to 7 generate signals capable of controlling switching and deliver the signals to the switching network, then the switching network performs passive mapping based on the control signals from the digital logics 470, 570, 670 and 770.

The mixers generate IF signals (f_{IF}=f_{RF}−f_{LO}) from the RF signals and the LO signals assigned by the switching network, and the VGAs amplify or attenuate input signals with different values.

FIG. 4 is a block diagram illustrating an example of a receiver in which a beamformer is to be used, according to a first embodiment of the present invention.

RF signals R₁, R₂, . . . , R_{N} received via a plurality of, N, antennas 420, undergo frequency filtering and amplitude adjustment by passing through a BPF 430 and an LNA 440, and then are input to mixers 418-1, 418-2, . . . , 418-N for their down conversion-to-IF band. The BPF 430 removes signals in the unwanted frequency band, the LNA 440 amplifies the signals to amplify low-power signals transmitted from a transmitter, and the mixers 418-1, 418-2, . . . , 418-N down-convert a frequency of the RF signals.

As LO signals for the mixers 418-1, 418-2, . . . , 418-N, LO signals LO₁, LO₂, . . . , LO_{N} output from the switching network 416 are input to the mixers 418-1, 418-2, . . . , 418-N, respectively, and output signals of the mixers 418-1, 418-2, . . . , 418-N are f_{IF}=f_{RF}−F_{LO}. Phases of the output signals of the mixers 418-1, 418-2, . . . , 418-N have one of phase values of θ₁, θ₂, . . . , θ_{T}, since they are set to follow phase values of the LO signals. The down-converted output signals of the mixers 418-1, 418-2, . . . , 418-N undergo frequency filtering by an IF filter 450, and then are amplified or attenuated with gains of a₁, a₂, . . . , a_{N} in VGAs 419-1, 419-2, . . . , 419-N, respectively.

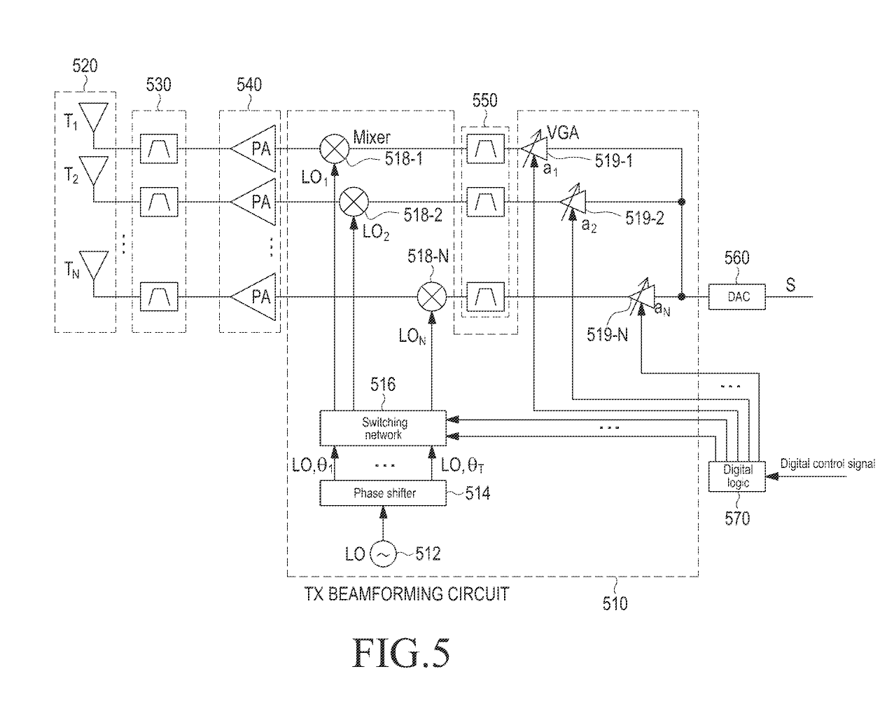

FIG. 5 is a block diagram illustrating an example of a transmitter in which a beamformer is to be used, according to the first embodiment of the present invention.

The transmitter in FIG. 5 operates in the reverse order of the receiver in FIG. 4.

Referring to FIG. 5, an LO signal generator 512 generates an LO signal, and a phase shifter 514 generates a predetermined number of phase-shifted LO signals with respect to the LO signal. A switching network 516 maps the phase-shifted LO signals to RF signals to be transmitted via a plurality of transmit paths.

Mixers 518-1, 518-2, . . . , 518-N mix signals that have undergone frequency filtering and amplitude adjustment with respect to their IF band signals, with the mapped LO signals. Specifically, the IF signals which are amplified or attenuated with different values by VGAs 519-1, 519-2, . . . , 519-N and one of the phase-shifted LO signals are input to the mixers 518-1, 518-2, . . . , 518-N, thereby to generate phase-shifted RF signals (f_{RF}=f_{IF}+f_{LO}).

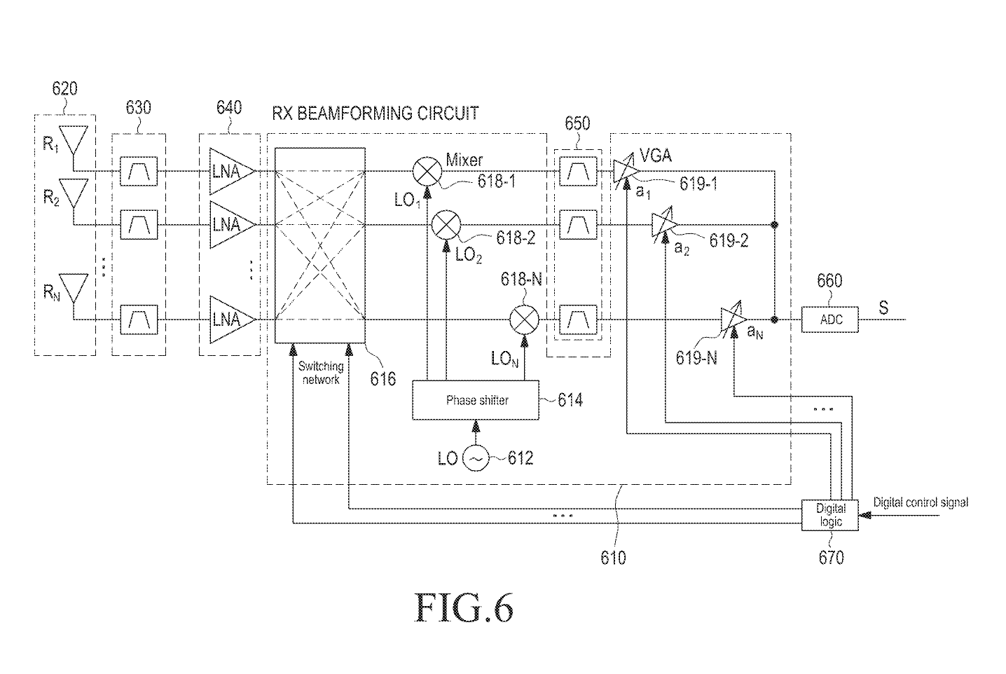

FIG. 6 is a block diagram illustrating a beamformer in a receiver according to a second embodiment of the present invention.

The receiver in FIG. 6 is equal in basic operation to the receiver in FIG. 4, but has the following differences.

Outputs of an LNA 640 are input to a switching network 616 to select mixers 618-1, 618-2, . . . , 618-N having their desired phases of LO signals. Compared with the switching network 416 placed at the output of the phase shifter 414 in FIG. 4, the switching network 616 is placed at the output of the LNA 640, generating outputs of the mixers 618-1, 618-2, . . . , 618-N like in FIG. 4. From the perspective of the mixers, for the mixers 418-1, 418-2, . . . , 418-N in FIG. 4, their RF signals are fixed and they are structured to selectively receive LO input signals. However, for the mixers 618-1, 618-2, . . . , 618-N in FIG. 6, their LO input signals are fixed and they are structured to selectively receive RF input signals.

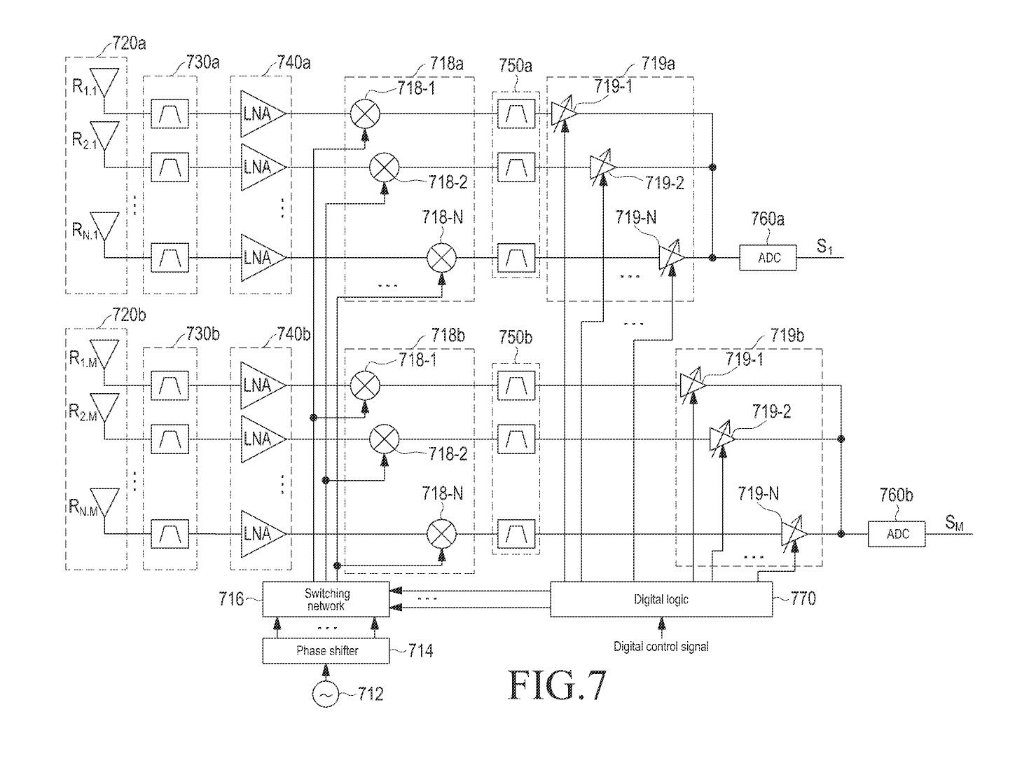

FIG. 7 is a block diagram illustrating a structure of an M-MIMO receiver using beamformer according to a third embodiment of the present invention.

The M-MIMO receiver consists of a plurality of the receivers shown in FIG. 4, and it is equal in operation to the receiver in FIG. 4.

An LO signal generator 712 generates a phase-locked signal. A phase shifter 714 receives a signal generated by the LO signal generator 712, and outputs T signals whose phases are shifted by θ₁, θ₂, . . . , θ_{T}, respectively. A switching network 716 matches one of the T signals output from the phase shifter 714 to N receive paths in which signals are received via a plurality of MIMO antennas 720a and 720b.

Output values of the switching network 716 are input to a plurality of mixers 718a and 718b.

The multiple mixers 718a and 718b generate IF signals (f_{IF}=f_{RF}−f_{LO}) from the RF signals and the LO signals assigned by the switching network 716, and VGAs 719a and 719b amplify or attenuate their input signals with different values.

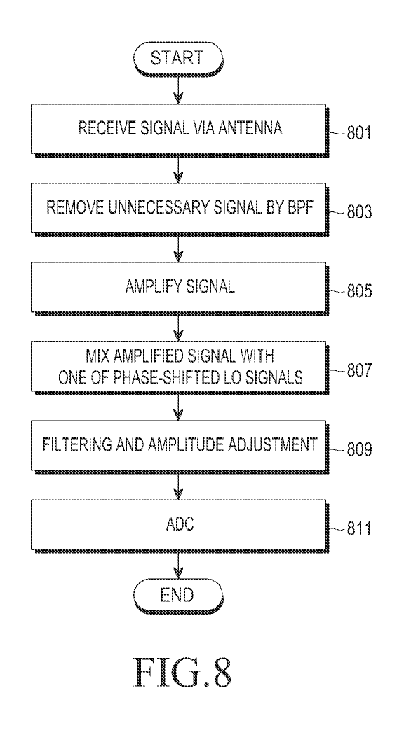

FIG. 8 is a flowchart illustrating a reception operation according to an embodiment of the present invention.

The receiver receives RF signals R₁, R₂, . . . , R_{N} via a plurality of, N, antennas 420 in step 801, and removes unnecessary signals by means of a BPF 430 in step 803. Thereafter, in step 805, the receiver amplifies signals by means of the LNA 440, and then inputs the amplified signals to the mixers 418-1, 418-2, . . . , 418-N for their down conversion-to-IF band.

In step 807, the receiver mixes the amplified signals with one of the LO signals LO₁, LO₂, . . . , LO_{N} output from the switching network 416, generating IF signals (f_{IF}=f_{RF}−f_{LO}). Since the receiver uses one phase-shifted LO signal, the receiver may improve the Signal-to-Noise Ratio (SNR), reduce the burden on a dynamic range of the ADC, and reduce the number of components, contributing to a reduction in power consumption.

After step 807, the receiver performs filtering and amplitude adjustment in step 809, and converts analog signals into digital signals (ADC) in step 811.

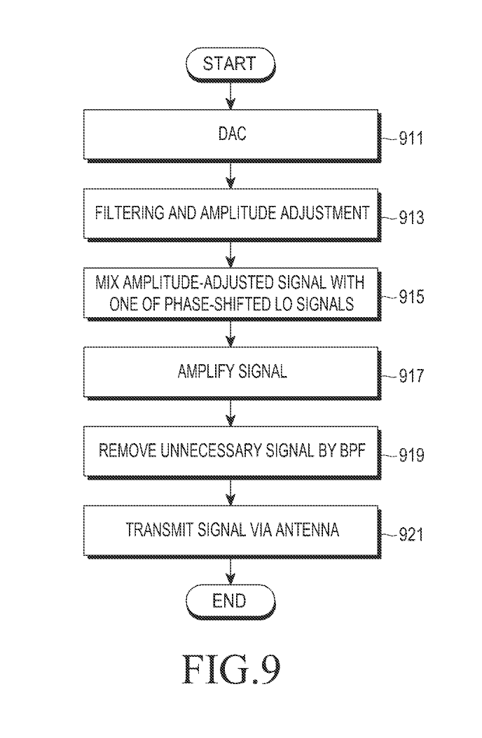

FIG. 9 is a flowchart illustrating a transmission operation according to an embodiment of the present invention.

The transmission operation is a reverse operation of the reception operation in FIG. 8. The transmitter converts digital signals into analog signals (DAC) by means of the DAC 560 in step 911, and performs filtering and amplitude adjustment in step 913.

Thereafter, in step 915, the transmitter mixes the amplitude-adjusted signals with one of the LO signals phase-shifted according to an embodiment of the present invention, generating f_{RF}=f_{IF}+f_{LO} as a resulting signal frequency. The transmitter amplifies the RF signals in step 917 to transmit them to a receiver, removes unnecessary signals by means of the BPF 530 in step 919, and transmits the signals via the antenna 520 in step 921.

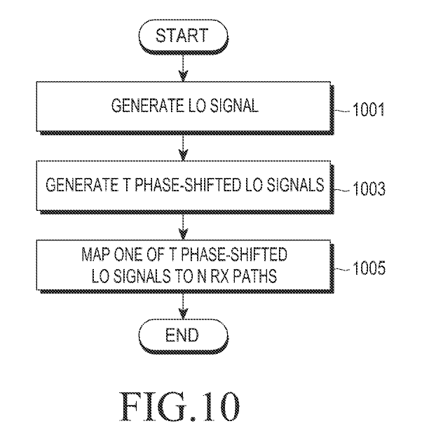

FIG. 10 is a flowchart illustrating an LO signal generation method according to an embodiment of the present invention.

In step 1001, the LO signal generator generates an LO signal and delivers it to a phase shifter. In step 1003, the phase shifter generates T phase-shifted LO signals with respect to the LO signal, and transfers them to a switching network. In step 1005, the switching network maps one of the T phase-shifted LO signals to N receive paths. The mapped LO signal is delivered to a mixer. The operation of FIG. 10 is applied to all of FIGS. 4 to 9.

The present invention has the following advantages since the phase shifter and the switching network are added.

Compared with the existing structure of performing beamforming using the passive phase shifters and the attenuators in the RF band, the proposed new structure may reduce the module size because it performs active element-based beamforming and the antenna paths share one LO signal generator. In addition, compared with the prior art of summing path signals in the RF domain before post processing, the present invention may increase the SNR and reduce the burden on a dynamic range of the ADC because it sums path signals in the analog domain.

In implementation of digital beamforming, the system implementation complexity increases because each antenna path needs to have an ADC. However, the present invention needs only one ADC because the paths may share an ADC.

As is apparent from the foregoing description, the present invention may optimize both the system performance and the number of components. Further, the present invention may minimize the power consumption. In addition, the present invention may improve the SNR and reduce the burden on a dynamic range of the ADC. Besides, the present invention may reduce the module size because the antenna paths share an LO signal generator.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A beamforming apparatus in a receiver in a mobile communication system, the beamforming apparatus comprising:
a Local Oscillator (LO) signal generator for generating an LO signal;
a phase shifter for generating a predetermined number of phase-shifted LO signals with respect to the generated LO signal;
a switching network for mapping the phase-shifted LO signals to RF signals received via a plurality of receive paths; and
a mixer for mixing the RF signals with the mapped LO signals to down-convert a frequency of the RF signals.

2. The beamforming apparatus of claim 1, further comprising a Variable Gain Amplifier (VGA) for adjusting amplitude of the down-converted signals.

3. The beamforming apparatus of claim 1, wherein the plurality of receive paths share one LO signal generator.

4. The beamforming apparatus of claim 1, wherein the plurality of receive paths share one Analog-to-Digital Converter (ADC).

5. The beamforming apparatus of claim 1, wherein the mixer subtracts the mapped LO signals from the RF signals, or subtracts the RF signals from the mapped LO signals.

6. A beamforming method in a receiver in a mobile communication system, the beamforming method comprising:
generating a Local Oscillator (LO) signal;
generating a predetermined number of phase-shifted LO signals with respect to the generated LO signal;
mapping the phase-shifted LO signals to RF signals received via a plurality of receive paths; and
mixing the RF signals with the mapped LO signals to down-convert a frequency of the RF signals.

7. The beamforming method of claim 6, further comprising adjusting amplitude of the down-converted signals.

8. The beamforming method of claim 6, wherein the plurality of receive paths share one LO signal generator.

9. The beamforming method of claim 6, wherein the plurality of receive paths share one Analog-to-Digital Converter (ADC).

10. The beamforming method of claim 6, wherein the mixing comprises subtracting the mapped LO signals from the RF signals, or subtracting the RF signals from the mapped LO signals.

11. A beamforming apparatus in a transmitter in a mobile communication system, the beamforming apparatus comprising:
a Local Oscillator (LO) signal generator for generating an LO signal;
a phase shifter for generating a predetermined number of phase-shifted LO signals with respect to the generated LO signal;
a switching network for mapping the phase-shifted LO signals to RF signals to be transmitted via a plurality of transmit paths; and
a mixer for mixing signals that have undergone frequency filtering and amplitude adjustment with respect to an Intermediate Frequency (IF) band signal, with the mapped LO signals, to up-convert a frequency of the IF band signals.

12. The beamforming apparatus of claim 11, further comprising a Variable Gain Amplifier (VGA) for adjusting amplitude of the IF band signal.

13. The beamforming apparatus of claim 11, wherein the plurality of transmit paths share one LO signal generator.

14. The beamforming apparatus of claim 11, wherein the plurality of transmit paths share one Digital-to-Analog Converter (DAC).

15. The beamforming apparatus of claim 11, wherein the mixer subtracts the mapped LO signals from the signals that have undergone frequency filtering and amplitude adjustment with respect to the IF band signal, or subtracts the signals that have undergone frequency filtering and amplitude adjustment with respect to the IF band signal, from the mapped LO signals.

16. A beamforming method in a transmitter in a mobile communication system, the beamforming method comprising:
generating a Local Oscillator (LO) signal;
generating a predetermined number of phase-shifted LO signals with respect to the generated LO signal;
mapping the phase-shifted LO signals to RF signals to be transmitted via a plurality of transmit paths; and
mixing signals that have undergone frequency filtering and amplitude adjustment with respect to an Intermediate Frequency (IF) band signal, with the mapped LO signals, to up-convert a frequency of the IF band signals.

17. The beamforming method of claim 16, further comprising adjusting amplitude of the IF band signal.

18. The beamforming method of claim 16, wherein the plurality of transmit paths share one LO signal generator.

19. The beamforming method of claim 16, wherein the plurality of transmit paths share one Digital-to-Analog Converter (DAC).

20. The beamforming method of claim 16, wherein the mixing comprises subtracting the mapped LO signals from the signals that have undergone frequency filtering and amplitude adjustment with respect to the IF band signal, or subtracting the signals that have undergone frequency filtering and amplitude adjustment with respect to the IF band signal, from the mapped LO signals.
